(19) United States
(12) Patent Application Publication
(10) Pub. No.: US 2004/0234095 A1
(43) Pub. Date: Nov. 25, 2004

(54) Sound reproducing system using sound pressure

(76) Inventor: Jung-Hoon Yun, Kyungki-do (KR)

Correspondence Address: SCHWEITZER CORNMAN GROSS & BONDELL LLP, 292 MADISON AVENUE - 19th FLOOR, NEW YORK, NY, 10017, US

(21) Appl. No.: 10/485,598

(22) PCT Filed: Jul. 26, 2002
(86) PCT No.: PCT/KR02/01421

(30) Foreign Application Priority Data
Jul. 31, 2001 (KR) 2001/0046140
Jan. 22, 2002 (KR) 2002/0001989
Jun. 20, 2002 (KR) 2002/0034682
Jun. 26, 2002 (KR) 2002/0036169
Jul. 4, 2002 (KR) 2002/0038775

(51) Int. Cl. H04R 1/00; H04R 9/06; H04R 11/02

(52) U.S. Cl. 381/412; 381/400; 381/396; 381/409

(57) ABSTRACT

A sound reproducing system using sound pressure is disclosed. The sound reproducing system is constructed in such a manner that the conductive wire is arranged in multiple rows or columns and the gap between neighboring parts of the arranged wires is sealed up by a thin film alternately. In addition, sound pressure generated by a sound pressure generator passes through the gap between neighboring wires that is not sealed up and the wires are vibrated around the thin film so as to change the sound pressure, thereby reproducing sound.

### TECHNICAL FIELD

The present invention relates to a sound reproducing system according to control of sound pressure, and more particularly, to a sound reproducing system using sound pressure control according to wire vibration generated due to interaction of a fixed magnetic field of a magnet and a magnetic field caused by current flowing through a wire.

### BACKGROUND ART

Sound is vibration of air, that is, changes of pressure in air. To reproduce sound using the changes of pressure according to vibration of air is the principle of a sound reproducing system, i.e., a speaker.

A variety of kinds of sound reproducing systems have been proposed and they are classified into a coin type speaker including a cone-shaped, a dome-shaped and a horn-shaped speaker, a ribbon type speaker whose cone paper is driven overall to be used as a tweeter, a speaker constructed in a manner that two electrodes are arranged having a narrow distance between them to attract to or repulse each other by static electricity, and a high polymer speaker using piezo effect. The speaker is classified according to its frequency characteristic into a woofer that is a low-pitched tone dedicated speaker unit, a squawker or mid-range that is a mid-range sound dedicated speaker unit, and a tweeter that is a high-pitched tone dedicated speaker unit.

To understand the structure of a general speaker, the structure of the cone-shaped speaker widely being used is explained below. FIG. 1 is a cross-sectional view showing an example of a conventional cone-shaped speaker.

The cone-shaped speaker 10 is constructed in such a manner that a plate 14 having a center pole yoke 15 at the center is arranged under a frame 13 in which a cone paper 11 and a center cap 12 are formed, and a magnet 16 is placed around the outer side of the plate 14. In addition, a damper 17 is included between the inner side of the frame 13 and the inner side of the cone paper 11. The top of a voice coil 18 is connected with the inner side of the cone paper 11 and its bottom is placed between the inner side of the plate 14 and the outer side of the center pole yoke 15. Furthermore, an input terminal for receiving sound signals is located at an appropriate portion of the frame 13.

When an electric sound signal is inputted into the input terminal, current flows through the voice coil 18 so that the center pole yoke 15, the plate 14 and the magnet 16 form a magnetic circuit. Due to a magnetic field formed by this magnetic circuit, the voice coil 18 vibrates up and down with the outer side of the center pole yoke 15 in the center.

When the voice coil 18 operates upward according to the aforementioned principle, the cone paper 11 moves upward by the operation of the voice coil 18 to generate “+” sound pressure. On the other hand, when the voice coil 18 operates downward, the cone paper 11 moves downward according to the operation of the voice coil 18 to generate “−” sound pressure. Accordingly, a reproduced wave having the waveform curve shown in FIG. 2 is generated. In a case where the frequency range of the reproduced wave is 20 Hz˜20 kHz, it can be heard as a sound.

However, the above-described conventional speaker has the following problems.

The speaker's sound is radiated to the outside via the damper 17, cone paper 11 and center cap 12 according to the aforementioned operation principle. While the sound is being radiated to the outside through the serial operations, vibration and vibration sound caused by it are generated in the damper 17, cone paper 11 and center cap 12. The vibration sound generated in the damper 17, cone paper 11 and center cap 12 is mixed with a reproduced sound radiated from the speaker to the outside. As a result, the vibration sound becomes a cause of noise mixed with the sound generated from the speaker. This cause is a measure of the speaker's quality.

Furthermore, transient characteristics of the damper 17, cone paper 11 and center cap 12 are deteriorated in a process of converting an electric signal into mechanical vibration by the effect of inertia because of the vibration generated therein.

To solve these problems, the applicant proposed a sound reproducing system, which is disclosed in Korean Patent No. 1992-2443 and shown in FIG. 3. This system includes a magnetic circuit constructed of a cylinder 28 having three rooms communicating with one another vertically, a vibrator 25 horizontally contained in the central space of the cylinder 28, a center pole and yoke 21 fixed to one side of the vibrator 25, a plate 32, and a magnet 23, left and right gates of the outer side 25′ of the center of the vibrator 25, left and right inner walls of the cylinder 28, a high-pressure tank 29 connected with the left side of the cylinder 28, a low-pressure tank 29′ connected with the right side of the cylinder 28, and a horn 27 integrated with the central open part of the cylinder 28. With this configuration, when a sound signal voltage is applied to a pair of input terminals 23 and 23′, the left and right gates of the vibrator 25 change their positions according to the sound signal voltage to open/close the inner walls of the cylinder 28, thereby controlling the amount of sound pressure transmitted through the inner walls.

Though the aforementioned system is able to reproduce sound with quality superior to that of the conventional cone-shaped speaker, its vibrator 25 should be precisely fabricated for being controlled accurately according to sound signal voltage. However, there are limitations in precise control of the vibrator because of structural characteristics of the system. Due to these problems, it is difficult to mass-produce the speaker system to result in an increase in its manufacturing cost. As a result, it impedes popularization of a speaker with high sound quality.

### DISCLOSURE OF INVENTION

An object of the present invention is to provide a sound reproducing system being capable of reproducing sound with high quality and having a new structure adapted for mass production.

Another object of the present invention is to provide an omnidirectional sound reproducing system.

Yet another object of the present invention is to provide a sound pressure generator capable of preventing noise.

To accomplish the objects of the present invention, there is provided a sound reproducing system using sound pressure, comprising a sound pressure generator for generating sound pressure; a first center pole yoke having innumerable sound pressure passage holes through which the sound pressure generated by the sound pressure generator can pass; a magnet surrounding at least the first center pole yoke; a first plate surrounding the first center pole yoke, the first plate being placed between the magnet and the sound pressure generator; a second center pole yoke having innumerable sound pressure passage holes, the second center pole yoke being arranged having a predetermined distance from the first center pole yoke; a second plate surrounding the second center pole yoke, the second plate being placed adjacent to the magnet; and a sound pressure controller placed in a predetermined space between the first center pole yoke and the second center pole yoke, wherein the sound pressure controller is constructed in such a manner that the conductive wire is arranged in multiple rows or columns and the gap between neighboring parts of the arranged wires is sealed up by a thin film alternately, the wire of the sound pressure controller vibrating around the thin film according to interaction of a magnetic field working on the wire and a fixed magnetic field of the magnet and the magnetic field working on the wire being caused by current according to a sound signal applied to the wire.

It is preferable that the first center pole yoke and the first plate are integrated with each other and/or the second center pole yoke and the second plate are integrated with each other in order to prevent leakage of sound pressure or to facilitate an assembly process.

The sound pressure controller is constructed in such a manner that the conductive wire arranges in a frame having a predetermined shape whose center portion is opened.

The thin film is preferably made of at least one of raw rubber, polyester, polyethylene and Teflon.

Preferably, the sound reproducing system according to the invention is constructed by being divided for (+) sound pressure and (−) sound pressure.

To accomplish the objects of the present invention, there is also provided a sound reproducing system using sound pressure, comprising a sound pressure generator for generating sound pressure; a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other; and a magnet placed adjacent to the sound pressure controller, wherein the conductive wire vibrates according to interaction of a magnetic field of the magnet and a magnetic field generated caused by current flowing through the conductive wire of the sound pressure controller, the gap between the neighboring wires that is not sealed up is changed by vibration of the two conductive wires, and the sound pressure generated by the sound pressure generator is varied due to the change in the gap that is not sealed up when the sound pressure passes through the gap, thereby reproducing the sound signal applied to the wire.

To accomplish the objects of the present invention, there is also provided a sound reproducing system using sound pressure, comprising a sound pressure generator for generating sound pressure; a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other; and a magnet placed adjacent to the sound pressure controller, the magnet having a plurality of sound pressure passage holes, wherein the conductive wire vibrates according to interaction of a magnetic field of the magnet and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

To accomplish the objects of the present invention, there is provided a sound reproducing system using sound pressure, comprising a sound pressure generator for generating sound pressure; a container serving as a passage of the sound pressure generated by the sound pressure generator, a part of the container being opened, the sound pressure being inputted or outputted through the open part of the container; a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other, the sound pressure controller being attached to the open part of the container; and a magnet placed adjacent to the sound pressure controller, wherein the conductive wire vibrates according to interaction of a magnetic field of the magnet and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

### BRIEF DESCRIPTION OF THE DRAWINGS

Further objects and advantages of the invention can be more fully understood from the following detailed description taken in conjunction with the accompanying drawings, in which:

FIG. 1 is a cross-sectional view of a conventional speaker;

FIG. 2 is a waveform diagram showing the operation characteristic of the conventional speaker;

FIG. 3 is a cross-sectional view of another conventional speaker;

FIG. 4 is a cross-sectional view of an embodiment of a sound reproducing system using sound pressure according to the present invention;

FIG. 5 is an enlarged perspective view of a portion of the principal part of a sound pressure controller according to the present invention;

FIGS. 6A and 6B are cross-sectional views showing operation states of the sound pressure controller according to the present invention;

FIG. 7 is a cross-sectional view of another embodiment of the sound reproducing system according to the present invention;

FIG. 8 shows a sound reproducing system according to another embodiment of the present invention;

FIG. 9 is an exploded view of the sound pressure controller of FIG. 8;

FIG. 10 shows the structure of a sound pressure controller according to another embodiment of the present invention;

FIGS. 11A, 11B and 11C show another embodiments of the thin-film plane of FIG. 10;

FIG 11D show another embodiments of the thin-film plane of FIG. 6A;

FIGS. 12A and 12B show cross-sectional shapes of a thin-film support;

FIG. 13 shows the structure of a wire tension controller according to the present invention;

FIG. 14 shows the structure of a wire gap controller according to the present invention;

FIG. 15 shows the structure of a sound reproducing system according to another embodiment of the present invention;

FIG. 16 shows another embodiment of the sound pressure controller according to the present invention;

FIG. 17 shows the structure of a conductive wire according to another embodiment of the present invention;

FIG. 18 shows a thin film structure according to another embodiment of the present invention;

FIG. 19 shows a thin film structure according to another embodiment of the present invention;

FIG. 20 shows a magnet used for the sound pressure controller of FIG. 8;

FIG. 21 shows the structure of a sound reproducing system according to another embodiment of the invention;

FIGS. 22A to 22E show various embodiments of the magnet according to the present invention;

FIG. 23 shows the structure of a sound pressure passage of a magnet according to another embodiment of the present invention;

FIGS. 24A to 24D show magnet assembly structures according to another embodiments of the present invention;

FIGS. 25A and 25B show magnet assembly structures according to another embodiments of the present invention;

FIG. 26 shows the structure of a sound reproducing system using sound pressure according to an embodiment of the present invention;

FIG. 27 shows the structure of a cylindrical omnidirectional sound reproducing system according to an embodiment of the present invention;

FIG. 28 shows the structure of a cylindrical omnidirectional sound reproducing system according to another embodiment of the present invention;

FIG. 29 shows the structure of a magnet used for the sound reproducing system of FIG. 27;

FIG. 30 shows the structure of a magnet used for the sound reproducing system of FIG. 28;

FIG. 31 shows the structure of a sound reproducing system according to another embodiment of the present invention;

FIG. 32 shows the structure of a half-cylindrical sound reproducing system according to another embodiment of the present invention;

FIGS. 33A, 33B and 33C show the structures of sound pressure generators according to the present invention;

FIG. 34 shows a sound reproducing system to which a sound pressure generator according to another embodiment of the invention is applied;

FIG. 35 shows the sound pressure generator of FIG. 34;

FIG. 36 show two sound generators arranged in a row; and

FIG. 37 shows the structure of a sound pressure generator for preventing vibration and noise.

### BEST MODE FOR CARRYING OUT THE INVENTION

Reference will now be made in detail to the preferred embodiments of the present invention, examples of which are illustrated in the accompanying drawings.

FIG. 4 is a cross-sectional view of a sound reproducing system according to the present invention. A sound pressure generator 20 for generating sound pressure includes a tank-shaped cylinder for storing air pressure according to a high-pressure or low-pressure pump (not shown). A first center pole yoke 51 having innumerable sound pressure passage holes is attached to an open part of the cylinder. A magnet 30 such as a permanent magnet is arranged to surround at least the first center pole yoke 51. A first plate 50 made of iron (Fe) is placed between the magnet 30 and the sound pressure generator 20 to transmit the flow of magnetic field in the magnet 30 to the first center pole yoke 51.

A second center pole yoke 61 having innumerable sound pressure passage holes is arranged having a predetermined distance from the first center pole yoke 51, and a second plate 60 made of iron (Fe) is placed on the magnet 30 and surrounds the second center pole yoke 61. The second plate transmits the flow of magnetic field in the magnet 30 to the second center pole yoke 61.

It is preferable that the first center pole yoke and the first plate are integrated with each other or the second center pole yoke and the second plate are integrated with each other, compared to the case where they are fabricated being separated from each other, in order to facilitate fabrication and prevent sound pressure leakage.

A sound pressure controller 40 fabricated according to the present invention is placed between the first center pole yoke 51 and the second center pole yoke 61, not coming into contact with them.

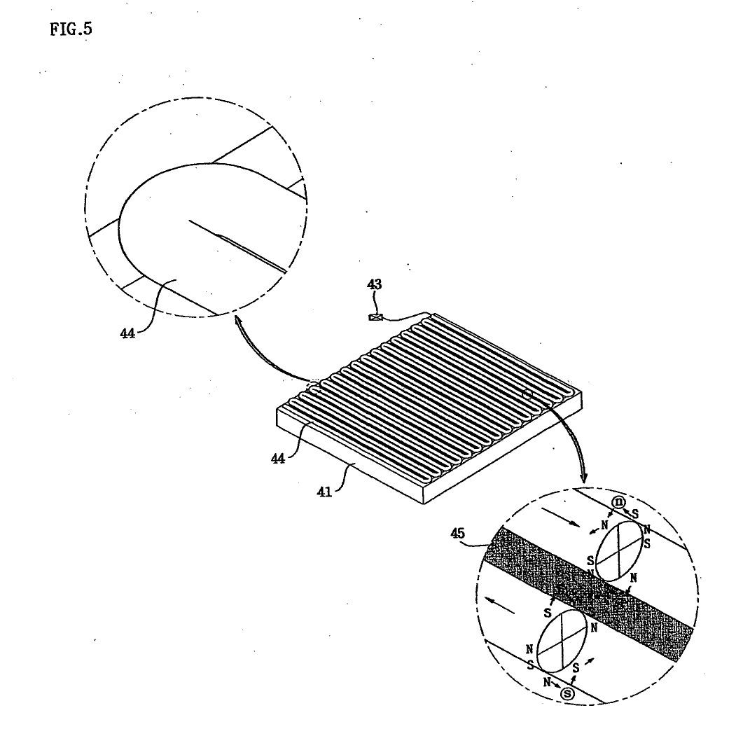

FIG. 5 shows the sound pressure controller in detail. Referring to FIG. 5, the sound pressure controller is constructed in such a manner that the conductive wire 44 having a diameter of 0.1 to 0.5 mm wire is arranged in multiple rows or columns and an elastic thin film 45 formed of raw rubber, polyester, polyethylene, silicon or the like seals up the gap between neighboring wire alternately. Here, it is desirable that the diameter of the conductive wire 44 is as small as possible for its vibration. If it is too small, however, impedance becomes too large. Accordingly, the material of the conductive wire is appropriately selected from gold, platinum, copper, aluminum, iron or the like in terms of impedance. Moreover, when a plurality of wires each of which has the diameter of 0.01 to 0.05 mm, being twisted, are used, as shown in FIG. 17, noise caused by wire vibration can be prevented. Instead of using the wire, it is possible to use the printed wire onto a thin film having an elastic property.

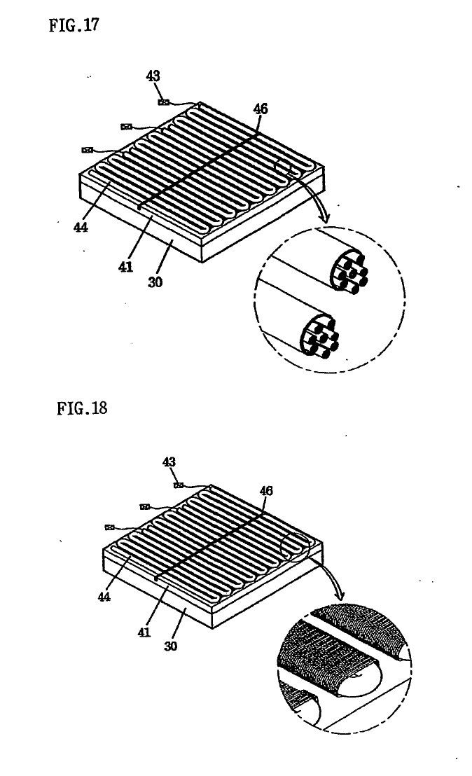

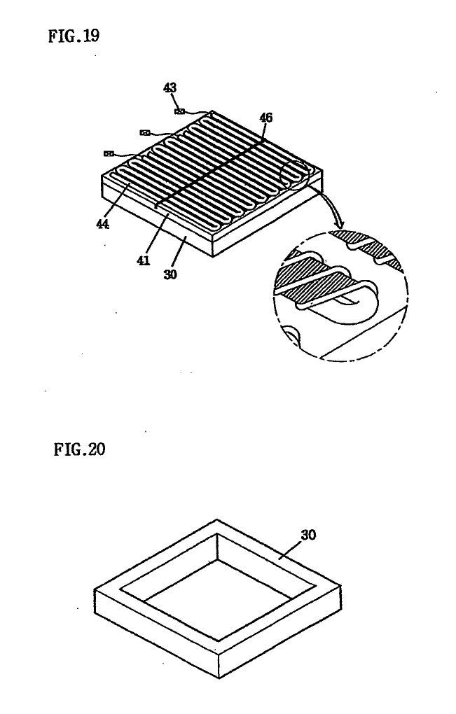

Furthermore, the material of the thin film is not limited to the elastic material. It is possible to employ an inelastic thin film instead of the elastic thin film and to use elasticity-restoring force according to tension of the wire. When pluralities of thin films are formed at the interval of 1 mm, the entire thin film becomes excessively thick or brings about a problem in its durability. Accordingly, the neighboring conductive wire parts are sealed up using a very fine fiber such as silk, as shown in FIG. 18. Otherwise, the neighboring wire parts can be wound by the fiber at intervals roughly and then coated with raw rubber, polyester, polyethylene, silicon or the like using a spray method, as show in FIG. 19.

Neighboring two wire parts that are not sealed up by the thin film 45 come into contact with each other or they are separated from each other having a small distance, for example, 0.1 to 0.5 mm, between them. Here, it is preferable that the gap between the neighboring wire parts, not being sealed up by the thin film, is 0.3 to 0.5 mm to allow the wires to be able to sufficiently vibrate in order to smoothly reproduce a low-pitched tone with large amplitude. Especially, when the neighboring two wire parts having the gap between them, which is not sealed up by the thin film, come into contact with each other, friction of them may become a cause of noise when the wire vibrates. In this case, the sound pressure controller 40 is constructed in a manner that the end of the wire 44 arranged is fixed to the edge of a frame whose center is opened.

The operation of the sound reproducing system according to the present invention is explained below with reference to the attached drawings.

When an audio system is powered on, the cylinder of the sound pressure generator 20 is provided with sound pressure according to a high-pressure pump or low-pressure pump (not shown) and this sound pressure passes through the sound pressure passage holes of the first center pole yoke 51. At this time, the parts of the wire of the sound pressure controller 40, which are not sealed up by the thin film, vibrate according to interaction of a fixed magnetic field of the magnet and a magnetic field caused by current due to a sound signal applied to the wires. Owing to this vibration, the gap between the wire parts that is not sealed up by the thin film is changed so that the sound pressure passing through this gap is varied. The varied sound pressure is supplied to the second center pole yoke 61.

The wire vibration action of the sound pressure controller 40 is explained in more detail with reference to FIG. 5. The wire of the sound pressure controller 40 vibrates in a direction that two wire parts connected by the thin film 45 compress the thin film 45 when a sound signal voltage is applied to an input terminal 43. This is accomplished according to interaction of the fixed magnetic field ((n) and (s) in the figure) formed by the magnet 30 and the magnetic field caused by current applied to the wire, as shown in FIG. 5.

In FIG. 5, (n) is a magnetic field component transmitted through the second plate 60 and the second center pole yoke and (s) is a magnetic field component transmitted through the first plate 50 and the first center pole yoke 51. Magnetic fields are formed around the wire according to the current flowing through the wire. The wire magnetic fields adjacent to the magnetic field component (n) of the magnet 30 are (N) and (S). Here, magnetic fields having the same polarity repel each other and magnetic fields having different polarities attract to each other. That is, since the magnetic field of the magnet 30 is fixed and the wire can move in the direction of compressing the thin film, the fixed magnetic field of the magnet 30 and the magnetic field caused by the current flowing through the wire interact each other such that the wire compresses the thin film according to the current flowing through the wire.

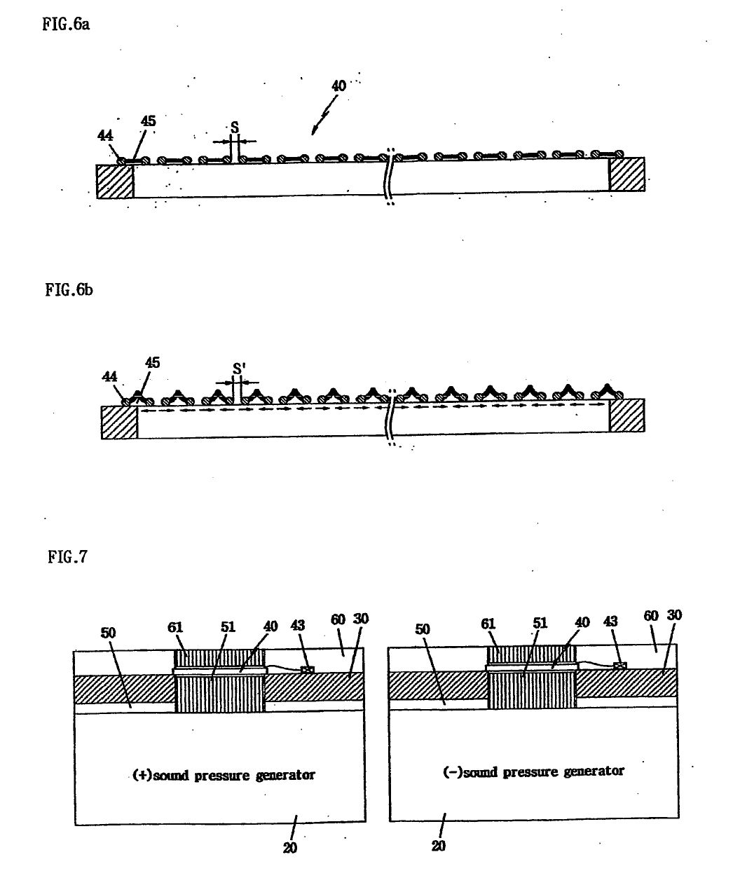

At this time, since the wire is arranged zigzag, two neighboring wire parts connected by the thin film have current flow directions opposite to each other and thus magnetic fields formed around the wire parts are also opposite to each other. Accordingly, as shown in FIG. 6B, the wire vibrates in the direction of compressing the thin film so that the gap S between the wire parts that is not sealed up by the thin film 45 is changed.

In other words, the wire parts that are not sealed up by the thin film come into contact with each other or have a small gap S between them before a sound signal is applied thereto, as shown in FIG. 6A. When the sound signal is applied through the input terminal 43, the wire 44 vibrates in the direction of compressing the thin film 45 to change the gap S between the wire parts that is not sealed up into a gap S′ so that sound pressure inputted from the first center pole yoke 51 is varied and transmitted to the second center pole yoke 61. Here, since the variation in the transmitted sound pressure depends on the sound signal applied to the wire, the sound pressure can be precisely controlled according to the sound signal. The variation in the sound pressure is reproduced as a sound.

The sound reproducing system of the present invention can be constructed in such a manner that it is divided into a system for (+) sound pressure and a system for (−) sound pressure, as shown in FIG. 7. In this case, only a single sound signal with (+) or (−) sound pressure can be applied through the input terminal of the system. Although it is preferable that wires compressed by the elastic force of the thin film are restored to the state sufficiently rapidly before they vibrate, the system can be designed in a manner that a small (−) sound pressure component is applied to the (+) sound pressure system to support the restoration of the wires by the elastic force, as shown in FIG. 2, according to the designer's intention. Here, the (+) sound pressure means that sound pressure is transmitted from the sound reproducing system to the outside and the (−) sound pressure means that sound pressure is transmitted into the sound reproducing system from the outside.

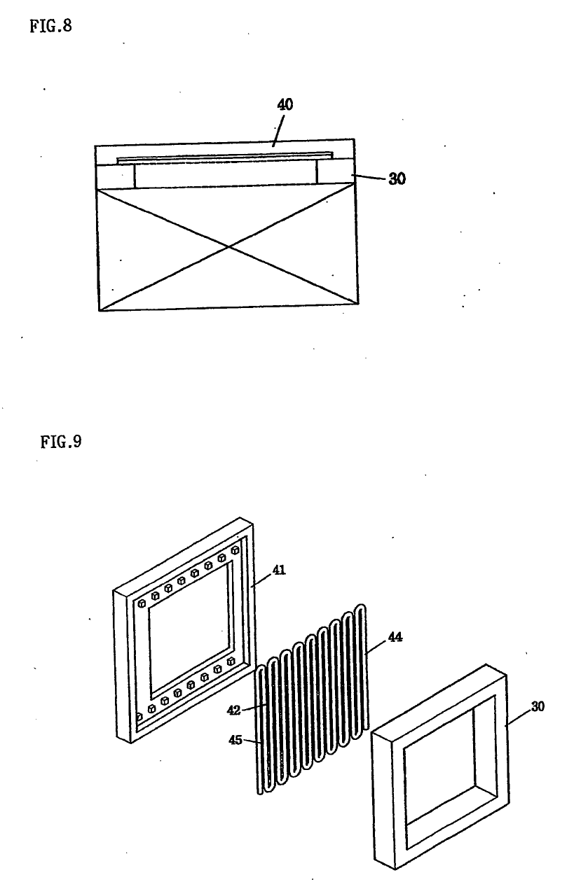

FIGS. 8 shows the structure of a sound reproducing system according to another embodiment of the invention and FIG. 9 is an exploded view of a sound pressure controller of the system. Referring to FIGS. 8 and 9, the sound pressure controller 40 is constructed in such a manner that the conductive wire 44 is arranged in rows or columns in a frame 41 whose center portion is opened, and the gap between neighboring wire parts is sealed up by the thin film 45 alternately. In addition, the sound pressure controller 40 is constructed in a manner that, when sound signal current is applied to neighboring conductive wire parts having the gap 42 between them that is not sealed up by the thin film, the direction of sound signal current flowing through the one of the two wire parts becomes opposite to the direction of sound signal current flowing through the other one. The magnet 30 is placed adjacent to the sound pressure controller 40 having a predetermined distance between them. Here, the sound pressure generator 20 must be sealed up so as not to allow sound pressure to leak to the magnet 30 or sound pressure controller 40.

The sound reproduction principle of the sound reproducing system shown in FIG. 8 is similar to that of the system shown in FIGS. 4, 5 and 6 except that the magnetic field caused by the magnet 30 is not guided through the center pole yoke.

As shown in FIGS. 6A and 6B, consequently, the conductive wire 44 of the sound pressure controller 40 vibrates according to interaction of the fixed magnetic field of the magnet 30 and the magnetic field caused by current flowing through the conductive wire, and the gap between neighboring conductive wire parts, which is not sealed up, is changed according to the vibration of the wire. In addition, sound pressure generated by the sound pressure generator 40 varies according to the change of the gap that is not sealed up when it passes through the gap, thereby reproducing a sound signal applied to the wire.

The sound reproducing system shown in FIG. 8 can be constructed in a manner that it is divided into the (+) sound pressure system and (−) sound pressure system, as shown in FIG. 7.

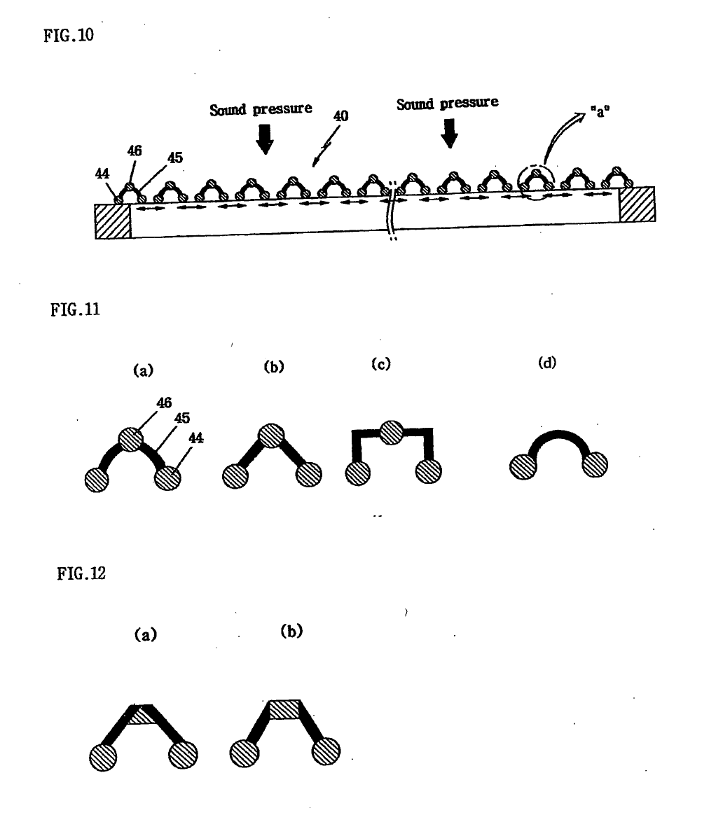

FIG. 10 shows another structure of the sound pressure controller 40 according to the present invention. In this structure, a thin-film support 46 is placed at the upper or lower part of the plane connecting two neighboring conductive wire parts 44, having a predetermined distance from the wire parts, and the thin film 45 seals the gaps between each of the wire parts 44 and thin-film support 46 up. Here, it is preferable that the thin-film support 46 is placed at the side to which sound pressure is provided. This is because sound pressure is supplied through the space between the wire parts and the thin-film support 46 so that noise is not generated when sound pressure travels from a wide portion to a narrow portion but it is generated when the sound pressure is changed from a narrow space to a wide space.

In the structure shown in FIG. 6A, compression of the sealed thin film requires very strong force because the thin film is long in the direction of its length and its width is as narrow as 0.8mm approximately. Accordingly, there is no serious problem in the reproduction of mid-range and a high-pitched tone with small amplitude but reproduction of a law-pitched tone with large amplitude brings about some problem. However, the structure shown in FIG. 10 (referred to as “wing-shape” hereinafter) has the advantage that it can vibrate with a little force because it does not vibrates to compress the thin film in the same direction as that of the thin film plane but vibrates being at a specific angle to the thin film plane.

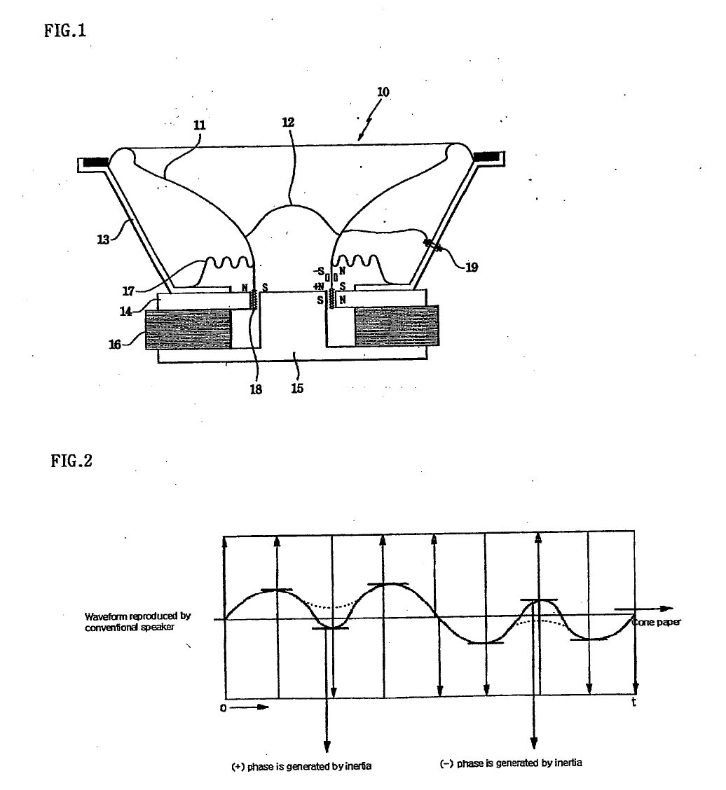

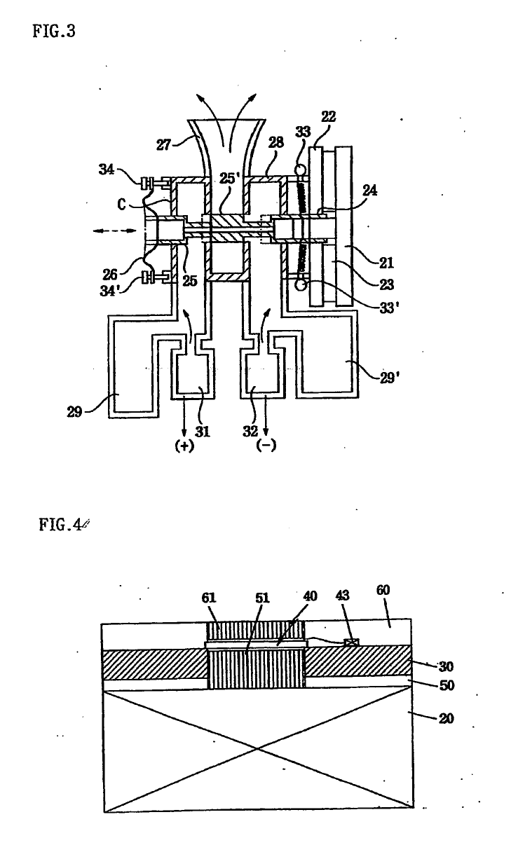

FIGS. 1IA, 11B and 11C show various cross-sectional shapes of the wing-shape unit of FIG. 10, in which the thin film 45 has a curved surface, a plane surface and a bent surface. Here, it is the most preferable that the structure is constructed such that the wire 44 can vibrate perpendicularly (at 90 degrees) to the thin film plane in order to facilitate vibration of the wire. Also, as shown in FIG. 11D, the cross-section structure of the thin film shown in FIG. 6A is defined in the form of “U” shape so that it is possible to facilitate vibration of the wire.

FIGS. 12A and 12B show various cross-section shapes of the thin-film support 46. It is preferable that the thin-film support 46 has a triangular or rectangular shape rather than a circular shape in order to facilitate sealing up of the thin film.

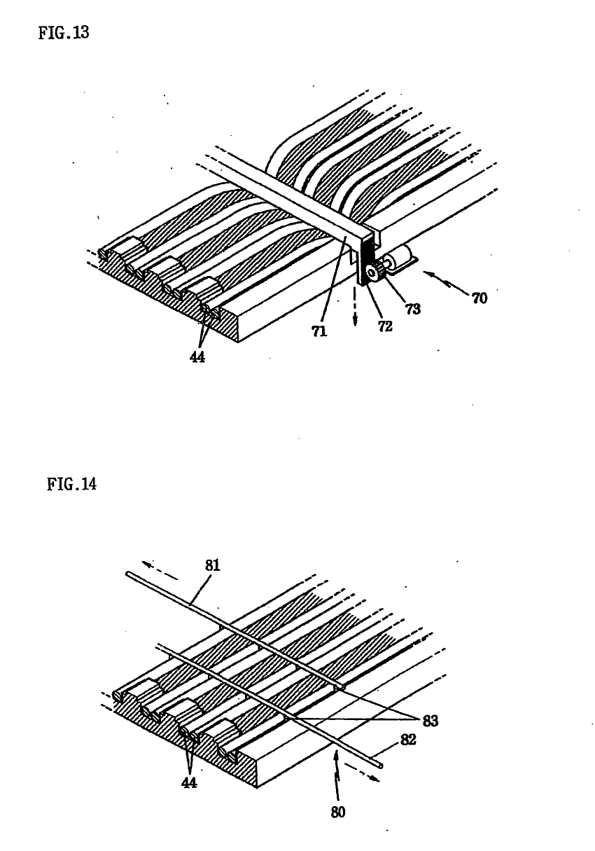

In the sound pressure controller 40 shown in FIG. 5, the overall tension of the conductive wire should be uniform. This is because vibration of the wire according to interaction of the magnetic fields is unbalanced if the tension is not uniform. This affects sound reproduction quality. FIG. 13 shows an example of a device 70 of controlling the tension of the wire of the sound pressure controller 40 for the purpose of solving the aforementioned problem.

Referring to FIG. 13, the wire tension controller 70 includes a pressing bar 71 crossing the running direction of the wire near one end of the wire 44, plane screw threads 72 formed at the end of the pressing bar in order to move the pressing bar downward, and rotary saw teeth 73 engaged with the plane screw threads 72. In this configuration, the pressing bar 71 can move up and down because the plane screw threads 72 can move rectilinearly according to the rotary motion of the rotary saw teeth 73.

In addition to the tension of the conductive wire 44, the gap between neighboring wire parts, which is not sealed up by the thin film 45, must be uniform for the overall wire. This is because sound pressure passes through the gap that is not sealed up by the thin film 45 to be varied so that the quality of reproduced sound becomes non-uniform and the sound may become noise due to the non-uniform quality if the gap is not uniform for the overall wire.

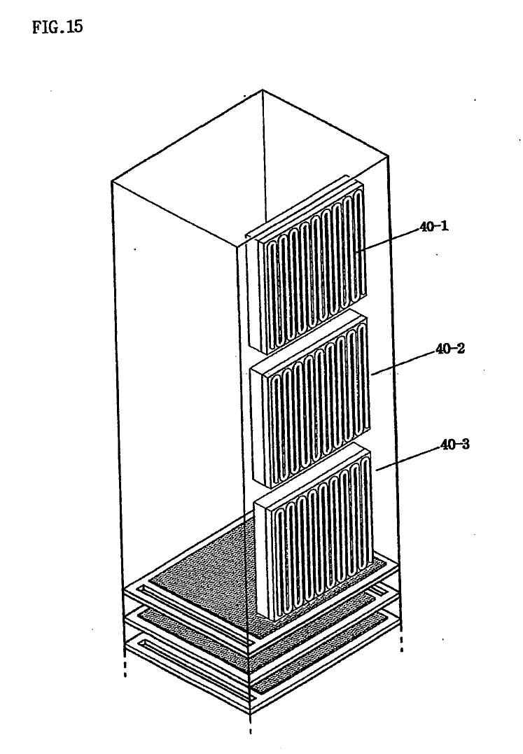

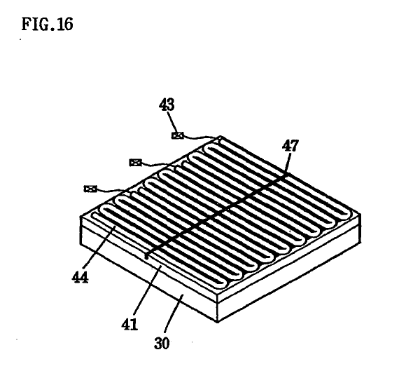

FIG. 14 shows a device 80 for controlling the gap between neighboring wire parts, which is not sealed up by the thin film. This wire gap controller 80 is constructed in such a manner that two support bars 81 and 82 are arranged perpendicular to the running direction of the wire 44 and a protrusion 83 inserted into the gap between neighboring wire parts is formed at each support bar. In this configuration, the support bars 81 and 82 are moved in directions opposite to each other so as to control the gap between the neighboring wire parts.

The wire tension controller 70 and the wire gap controller 80 shown in FIGS. 13 and 14 are merely exemplary and various modifications of them can be made.

FIG. 15 shows another embodiment of the sound reproducing system according to the present invention, in which three sound pressure controllers 40-1, 40-2 and 40-3 are arranged in a single sound pressure generator 20. The three sound pressure controllers 40-1, 40-2 and 40-3 have the same structure and increase the overall quantity of sound pressure outputted to improve a sound pressure output level. In addition, the sound pressure controllers may be arranged for being used for a woofer, a mid-range and a tweeter, respectively, to improve full-range sound reproduction capability. Specifically, the gap between neighboring wire parts at which the thin film is not formed is set to 0.3 to 0.5 mm for the woofer, 0.2 mm for the mid-range, and 0 or 0.1 mm for the tweeter in the sound pressure controller 40. A sound reproduction band depends not only on the gap between neighboring wire parts that is not sealed up by the thin film but also on the gap between wire parts that is sealed up by the thin film 45, that is, the width or thickness of the thin film. This is because a thin wide thin film can increase vibration margin of the wire to reproduce a sound signal with large amplitude corresponding to a law-pitched tone.

In the structure shown in FIG. 5, the single conductive wire is arranged zigzag in rows or columns. Thus, if the wire becomes too long, its resistance increases to result in excessively large impedance. With the excessively large impedance, a sound signal applied to the wire becomes extinct due to the resistance of the wire while passing through the wire so that a magnetic field caused by the sound signal cannot be created and the wire cannot vibrate.

FIG. 16 shows another configuration of the sound pressure controller 40 for the purpose of solving the aforementioned problem. In this configuration, the conductive wire 44 is divided into multiple parts and a sound signal is simultaneously applied to the conductive wire parts. Furthermore, at least one portion 47 placed between both ends of the conductive wire arranged in multiple rows or columns is fixed so as to divide the sound pressure controller 40 into a plurality of cells. This prevents deviation in vibrations at the center of the wire and at both ends thereof in a case where the wire is excessively long. Moreover, when the wire vibrates to compress the thin film in the same direction as that of the thin film plane, the compression force should become larger if the length of the wire is excessively long.

FIG. 20 shows the structure of a magnet used for the sound reproducing system of FIG. 8. The magnet is constructed of a square frame whose center portion is opened. Sound pressure generated by the sound pressure generator 20 passes through the space at the center of the frame and passes through the gap between neighboring wire parts of the sound pressure controller 40, which is not sealed up. The magnet 30 should provide a uniform fixed magnetic field to the overall face of the sound pressure controller 40 corresponding to the opened central space thereof in order to uniformly vibrate the wire. However, as the size of the magnet increases, the difference between the magnetic field at the opened central space and the magnetic field at the outer portion of the magnet becomes large. For example, in case of the neodymium magnet in size of 10 cm×15 cm, the intensity of magnetic field at the outer portion thereof is 4000 Gauss and the intensity of magnetic field at the center thereof is 1500 Gauss, which means very large deviation in the magnetic fields.

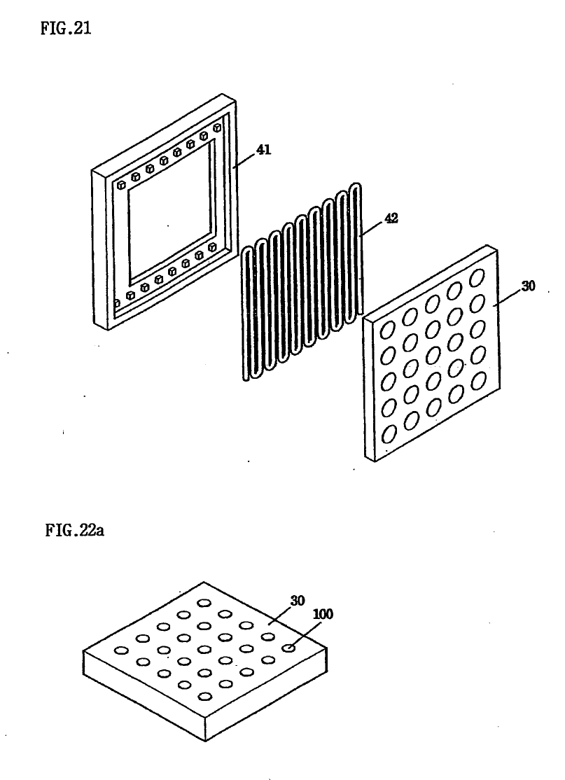

FIG. 21 shows a structure for the purpose of preventing non-uniform magnetic field of a large-size magnet. The structure of the sound pressure controller 40 is identical to the structure shown in FIG. 8 except that the magnet 30 has a plurality of sound pressure passage holes. That is, sound pressure passes through the single space at the center of the magnet in FIG. 20 whereas sound pressure passes through the plurality of sound pressure passage holes to be reproduced as a sound through the sound pressure controller 40 adjacent to the magnet in FIG. 21. The structure shown in FIG. 21 has the advantage of capable of vibrating the wire in close proximity to the sound pressure passage holes as uniformly as possible.

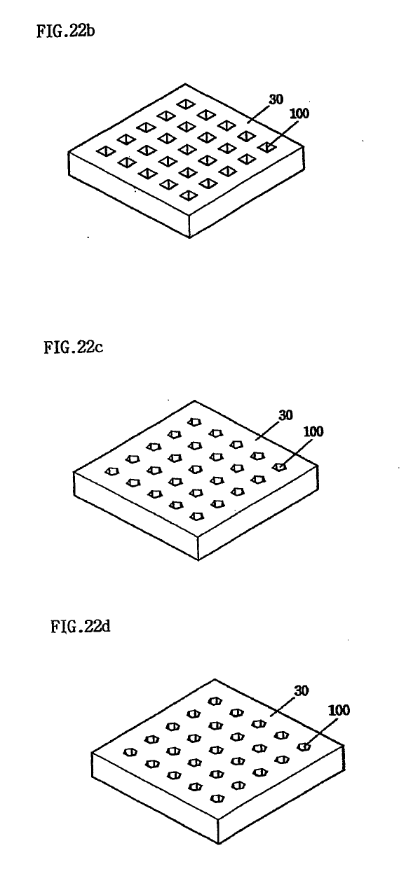

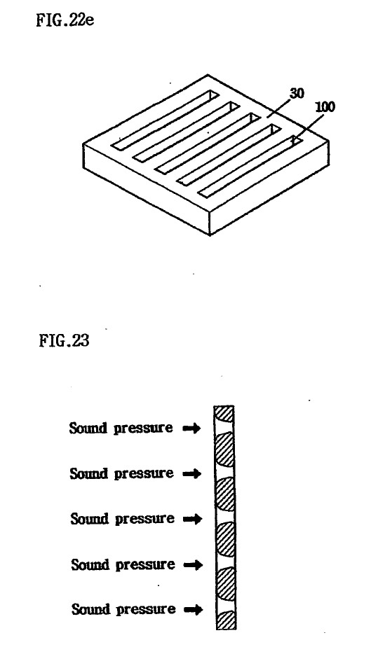

FIGS. 22A to 22E show various structures of the sound pressure passages formed at the magnet 30 according to the present invention. The sound pressure passages can be formed in the shape of circle, square, pentagon, hexagon and long slit, as shown in FIGS. 22A to 22E.

FIG. 23 shows the shape of the sound pressure passages 100 of the magnet 30 according to the present invention. As shown in FIG. 23, each sound pressure passage can be formed such that it becomes narrower as it goes from its inlet toward its outlet. Furthermore, it is preferable that the borders of the inlet and outlet are rounded off and each sound pressure passage has a cylindrical shape because sound pressure generates noise when it collides with an angular portion in view of aerodynamics.

FIGS. 20 and 22A to 22E show the magnet having the central opened portion and the magnet having the plurality of sound pressure passage holes. To manufacture a large-sized magnet of these kinds requires large amount of manufacturing cost. Furthermore, it is very difficult to design the shape of the magnet freely with a low cost in terms of the characteristic of the magnet using ferrite or neodymium as its material.

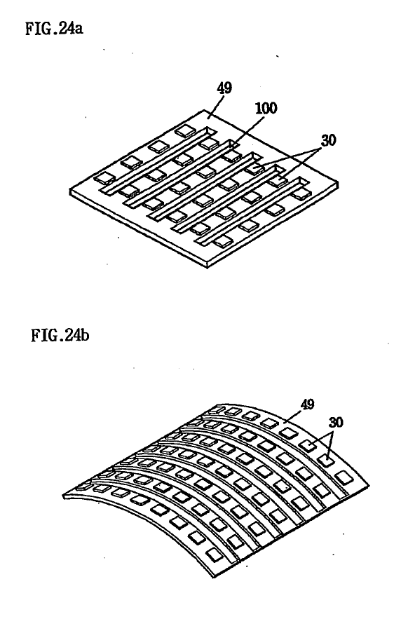

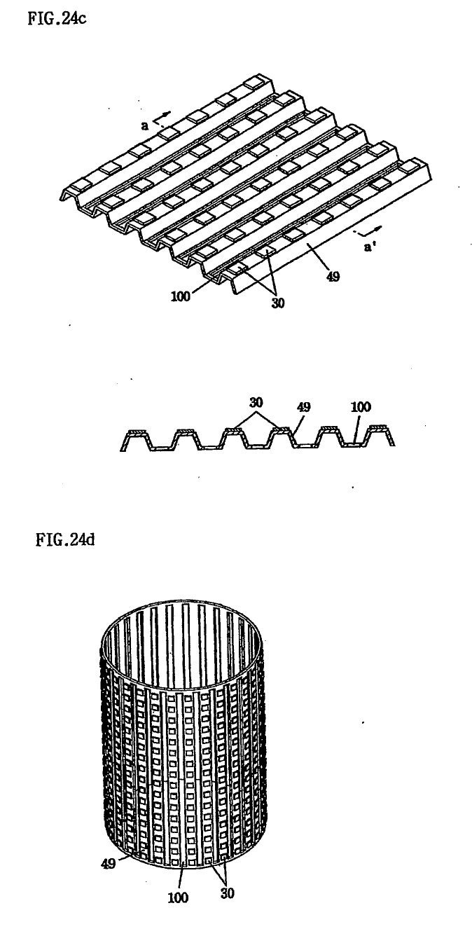

FIGS. 24A to 24D show various magnet assembly structures according to embodiments of the present invention. The magnet assemblies are commonly constructed in a manner those pluralities of small magnet pieces 30 are attached to a support plate 49 in which a plurality of sound pressure passages are formed. The magnet pieces 30 are attached around the sound pressure passages. This structure can be fabricated in various shapes including a plane shape of FIG. 24A, a curved shape of FIG. 24B, an uneven surface shape of FIG. 24C and a cylindrical shape of FIG. 24D. It is also possible to form the structure in a spherical or dome shape, which is not shown.

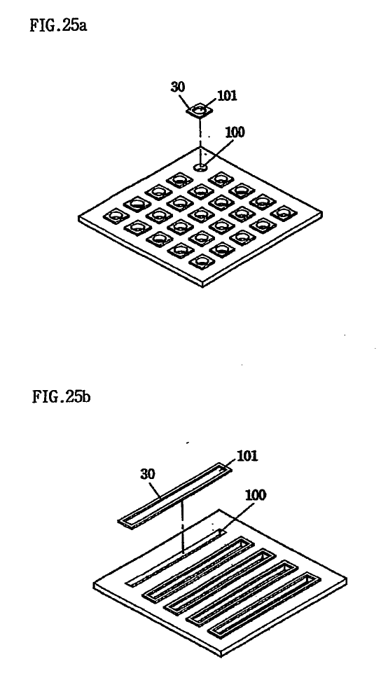

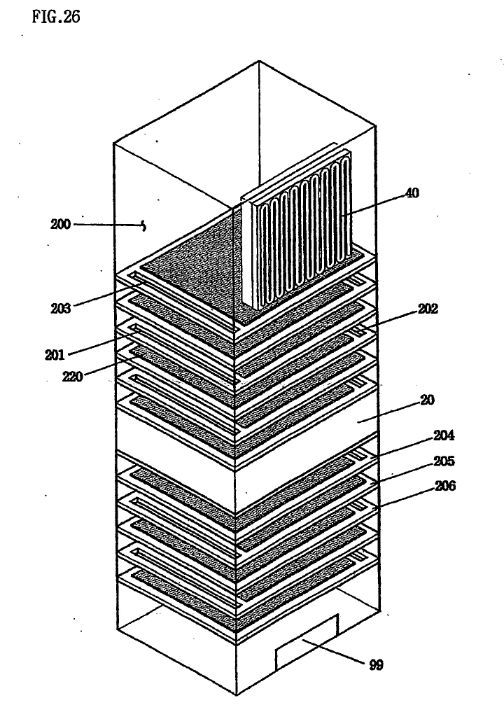

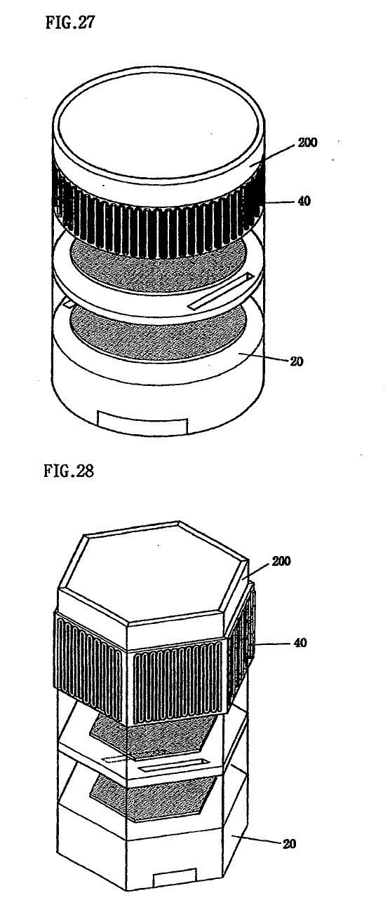

FIGS. 25A and 25B show structures in which sound pressure passage holes similar to the sound pressure passages of the support plate 49 are formed in magnet pieces 30 and the magnet pieces are attached onto the support plate 49 so that the sound pressure passages of the support plate 49 overlap with the sound pressure passage holes of the magnet pieces 30.

FIG. 26 shows the structure of the sound reproducing system using sound pressure according to the present invention. The sound reproducing system includes the sound pressure generator 20 for generating sound pressure, a container 200 serving as a passage of the sound pressure generated by the sound pressure generator 20, and the sound pressure controller 40 attached to an open part of the container 200 through which the sound pressure is inputted or outputted.

The inner space of the container 200 between the sound pressure generator 20 and the sound pressure controller 40 is divided into a plurality of sections communicating with one another to form sound pressure passages 201, 202 and 203. A sound-absorbing material 220 such as sponge is attached onto the surface of each section to absorb noise generated from the sound pressure generator 20. It is necessary to reduce noise in terms of characteristics of the sound reproducing system. Accordingly, the inner space of the container 200 is divided into multiple sections to make the sound pressure passage longer and the sound-absorbing material is attached to the surface of each section, as described above.

Moreover, it is preferable that the container is extended and the space under the sound pressure generator 20 is also divided into a plurality of sections to form passages 205 and 206 for the sound pressure transmitted from the sound pressure controller 40 or outputted to the sound pressure generator 20, as shown in FIG. 26, in order to prevent noise of the sound pressure generator from going out through a sound pressure outlet 99.

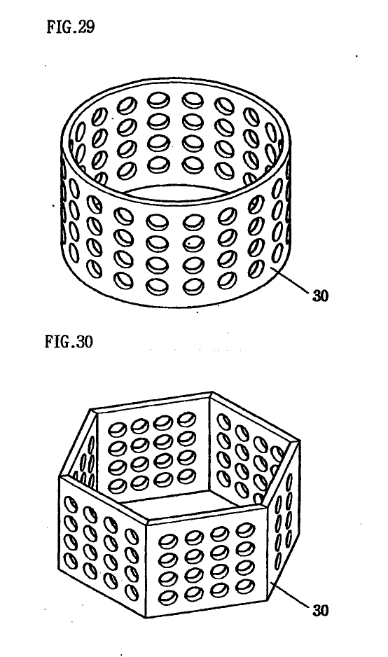

FIG. 27 shows the structure of a cylindrical omnidirectional sound reproducing system according to the present invention. In this structure, the container 200 shown in FIG. 26 is formed in a cylindrical shape, the circumferential portion of the container 200 in a specific width is opened, and a cylindrical sound pressure controller 40 is set in the opened part. For this structure, the cylindrical magnet having the plurality of sound pressure passage holes 100 shown in FIG. 24D or a magnet assembly 30 shown in FIG. 29 is used. In this case, sound pressure generated by the sound pressure generator 20 is outputted or inputted radially so that the omnidirectional sound reproducing system can be constructed.

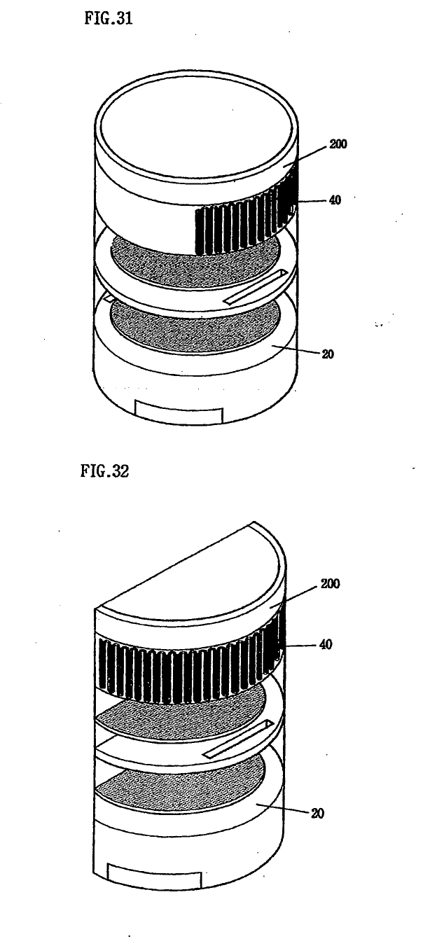

FIG. 28 shows the structure of an omnidirectional sound reproducing system according to another embodiment of the present invention. This structure is constructed in such a manner that the container 200 shown in FIG. 26 is formed in a hexagonal barrel shape, a predetermined width of each of the six sides of the container 200 is opened, and six plane sound pressure controllers 40 are respectively attached to the open parts of the six sides. In this case, the polygonal magnet 30 having the plurality of sound pressure passages 100 can be configured of six plane magnets or the magnet assembly 30 as shown in FIG. 30. With this structure, sound pressure generated by the sound pressure generator 20 is outputted or inputted through each side of the polygonal barrel to construct the omnidirectional sound reproducing system.

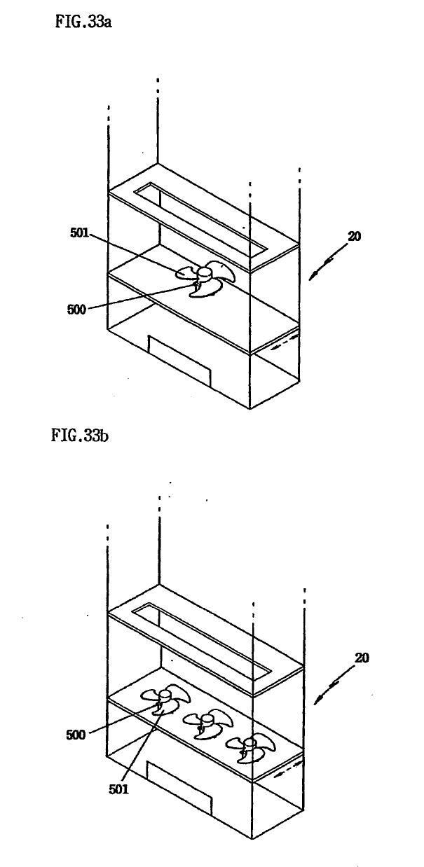

FIG. 31 shows the structure of a sound reproducing system according to another embodiment of the present invention. This structure is constructed in such a manner that the container 200 shown in FIG. 26 is formed in a cylindrical shape, a predetermined width of a half of the circumference of the container 200 is opened, and a half-cylindrical sound pressure controller 40 is set at the opened part. Here, a cylindrical magnet (not shown) having the plurality of sound pressure passage holes is used. As a result, sound pressure generated by the sound pressure generator 20 is inputted or outputted radially through the half-cylindrical face to extend sound reproducing angle.

FIG. 32 shows the structure of a half-cylindrical sound reproducing system according to another embodiment of the present invention. This structure is constructed in such a manner that the container 200 shown in FIG. 26 is formed in a half-cylindrical shape, a predetermined width of the half-cylindrical curved face of the container 200 is opened, and a half-cylindrical sound pressure controller 40 is set therein. Here, a cylindrical magnet (not shown) having the plurality of sound pressure passage holes is used. Consequently, sound pressure generated by the sound pressure generator 20 is outputted or inputted radially through the half-cylindrical face.

The sound pressure controller 40 can have a dome shape or a sphere shape (not shown) instead of the plane shape and half-cylindrical shape shown in FIGS. 26 and 32.

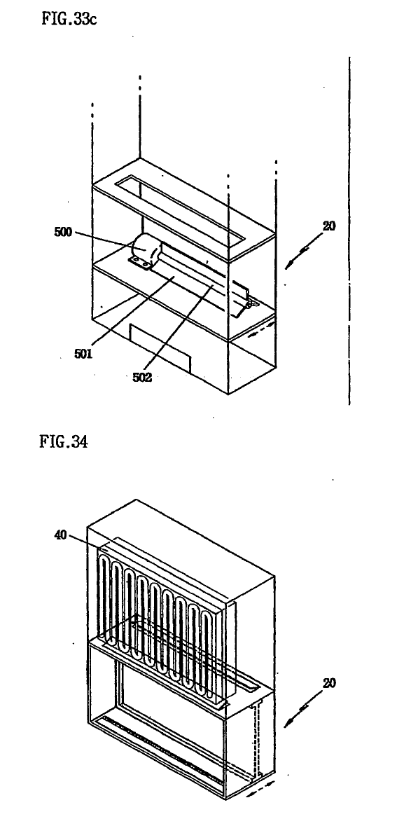

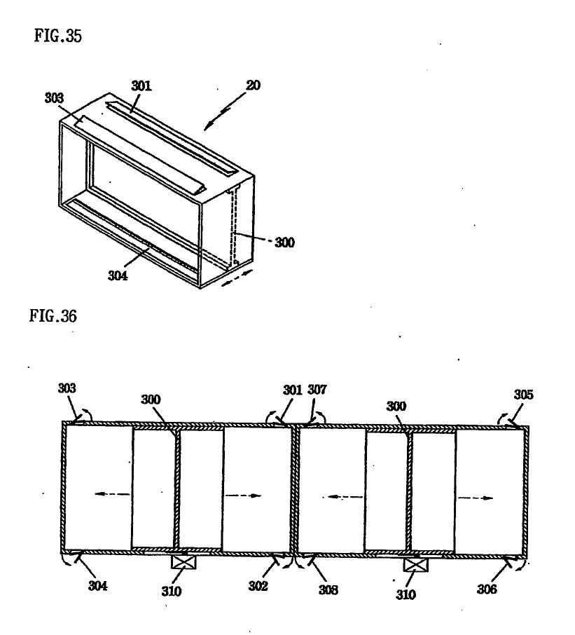

FIGS. 33A, 33B and 33C show embodiments of the sound pressure generator 20 according to the present invention. Referring to FIG. 33A, the sound pressure generator 20 has a motor or solenoid 500 to which a fan 501 is attached. In this structure, sound pressure is generated according to rotation of the fan 501. Referring to FIG. 33B, the sound pressure generator 20 is constructed in a manner that a plurality of small-size motors or solenoids 500 each of which has a fan 501 attached thereto are arranged in a row. This sound pressure generator is suitable for the flat type sound reproducing system.

FIG. 33C shows the sound pressure generator 20 including a motor or solenoid 500 that has a fan 501 with long wings in the length direction of a long fan support axis 502. This sound pressure generator is preferably applied to the flat type sound reproducing system with a narrow width.

FIGS. 34 and 35 respectively show a sound reproducing system to which a sound pressure generator 20 according to another embodiment of the invention is applied and the sound pressure generator. The sound pressure generator 20 includes an air compressor 300 reciprocating within a specific space, a driver (310 of FIG. 36) for reciprocating the air compressor 300, an exhaust valves 301 for discharging compressed air (sound pressure) out of the specific space when the air compressor 300 moves forward in one direction, and an inlet valve 302 for inhaling external air into the specific space when the air compressor 300 moves back in the opposite direction.

It is preferable that the sound pressure generator is constructed in such a manner that, when the air compressor 300 moves forward, the exhaust valve 301 operates and simultaneously another inlet value 304 operates in the space opposite to the moving direction of the air compressor 300. In addition, when the air compressor 300 moves back, another exhaust valve 303 operates and simultaneously the inlet value 302 operates in the space opposite to the moving direction of the air compressor 300. As shown in FIG. 36, two sound pressure generators according to reciprocation can be arranged in parallel to generate more uniform sound pressure.

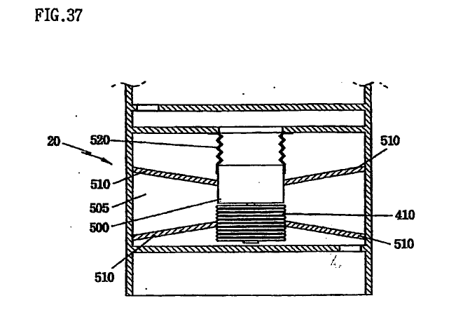

FIG. 37 shows a structure for preventing noise or vibration, which is generated when the sound pressure generator 20 using a motor or solenoid 500 that is excessively severely noisy or vibrating, from being transmitted to the outside or container 200. In this structure, the motor or solenoid 500 is set, being suspended by an elastic string 510, in a specific space 505 and air (sound pressure) generated by a fan (not shown) attached to the motor 500 is inhaled or exhausted through a pleated pipe 520 made of an elastic material such a rubber. With this configuration, transmission of vibration or noise of the motor or solenoid 500 through the container to the outside or container 200 can be minimized.

Industrial Applicability

According to the present invention described above, additional vibration sources including the damper, cone paper, center cap and the like are omitted so that vibration sounds can be prevented from being generated caused by the vibration sources in advance when a sound of the sound reproducing system is radiated to the outside. Thus, sound close to natural sound can be reproduced. Furthermore, the present invention simplifies the vibration structure for controlling sound pressure to facilitate mass production and to lower manufacturing cost, thereby popularizing the sound reproducing system with high sound quality.

According to the present invention, the structure of the magnet of the sound reproducing system using sound pressure is improved so that the shape of the sound reproducing system can be designed in various forms economically and sound pressure can be uniformly controlled for the overall face of even the large-sized sound reproducing system.

According to the present invention, the sound reproducing system using sound pressure can be fabricated in cylindrical, half-cylindrical, polygonal barrel and dome shapes. Thus, a sound generated from the sound reproducing system can be radiated omnidirectionally. Moreover, a sound pressure passage is divided into a plurality of sections and a sound-absorbing material is attached to the surface of each section, or the sound pressure generator is suspended in a space using an elastic string, to thereby minimize noise or vibration. Especially, the structure of the sound pressure generator is constructed in a variety of shapes so that a flat type sound reproducing system can be realized.

Although specific embodiments including the preferred embodiment have been illustrated and described, it will be obvious to those skilled in the art that various modifications may be made without departing from the spirit and scope of the present invention, which is intended to be limited solely by the appended claims.

1. A sound reproducing system using sound pressure, which reproduces a sound according to a sound signal, comprising:
a sound pressure generator for generating sound pressure;
a first center pole yoke having innumerable sound pressure passage holes through which the sound pressure generated by the sound pressure generator can pass;
a magnet surrounding at least the first center pole yoke;
a first plate surrounding the first center pole yoke, the first plate being placed between the magnet and the sound pressure generator;
a second center pole yoke having innumerable sound pressure passage holes, the second center pole yoke being arranged having a predetermined distance from the first center pole yoke;
a second plate surrounding the second center pole yoke, the second plate being placed adjacent to the magnet; and
a sound pressure controller placed in a predetermined space between the first center pole yoke and the second center pole yoke,
wherein the sound pressure controller is constructed in such a manner that the conductive wire is arranged in multiple rows or columns and the gap between neighboring parts of the arranged wires is sealed up by a thin film alternately, the wire of the sound pressure controller vibrating around the thin film according to interaction of a magnetic field working on the wire and a fixed magnetic field of the magnet, the magnetic field working on the wire being caused by current according to a sound signal applied to the wire.

2. The sound reproducing system as claimed in claim 1, wherein the first center pole yoke and the first plate are integrated with each other and/or the second center pole yoke and the second plate are integrated with each other.

3. The sound reproducing system using sound pressure, which reproduces a sound according to a sound signal, comprising:
a positive (+) sound pressure generator for generating (+) sound pressure;
a first center pole yoke having innumerable (+) sound pressure passage holes through which the sound pressure generated by the sound pressure generator can pass;
a magnet surrounding at least the first center pole yoke;
a first plate surrounding the first center pole yoke, the first plate being placed between the magnet and the (+) sound pressure generator;
a second center pole yoke having innumerable (+) sound pressure passage holes, the second center pole yoke being arranged having a predetermined distance from the first center pole yoke;
a second plate surrounding the second center pole yoke, the second plate being placed adjacent to the magnet;
a sound pressure controller placed in a predetermined space between the first center pole yoke and the second center pole yoke, the sound pressure controller being constructed in such a manner that the conductive wire is arranged in multiple rows or columns and the gap between neighboring parts of the arranged wires is sealed up by a thin film alternately;
a (−) sound pressure generator for generating (−) sound pressure;
a first center pole yoke having innumerable (−) sound pressure passage holes through which the (−) sound pressure generated by the (−) sound pressure generator can pass;
a magnet surrounding at least the first center pole yoke;
a first plate surrounding the first center pole yoke, the first plate being placed between the magnet and the (−) sound pressure generator;
a second center pole yoke having innumerable (−) sound pressure passage holes, the second center pole yoke being arranged having a predetermined distance from the first center pole yoke;
a second plate surrounding the second center pole yoke, the second plate being placed adjacent to the magnet; and
a sound pressure controller placed in a predetermined space between the first center pole yoke and the second center pole yoke, the sound pressure controller being constructed in such a manner that the conductive wire is arranged in multiple rows or columns and the gap between neighboring parts of the arranged wires is sealed up by a thin film alternately.

4. A sound reproducing system using sound pressure, comprising:
a sound pressure generator for generating sound pressure; and
a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other,
wherein the conductive wire vibrates according to a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

5. A sound reproducing system using sound pressure, comprising:
a sound pressure generator for generating sound pressure;
a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other; and
a magnet placed adjacent to the sound pressure controller,
wherein the conductive wire vibrates according to interaction of a magnetic field of the magnet and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

6. A sound reproducing system using sound pressure, comprising:
a (+) sound pressure generator for generating (+) sound pressure;
a (+) sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other;
a (−) sound pressure generator for generating (+) sound pressure; and
a (−) sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other,
wherein the conductive wire vibrates according to a magnetic field generated caused by current flowing through the conductive wire of the (+) or (−) sound pressure controller, the gap between the neighboring wires that is not sealed up is changed according to vibration of the two conductive wires, and the sound pressure generated by the (+) or (−) sound pressure generator is varied due to the change in the gap that is not sealed up when the sound pressure passes through the gap, thereby reproducing the sound signal applied to the wire.

7. A sound reproducing system using sound pressure, comprising:
a (+) sound pressure generator for generating (+) sound pressure;
a (+) sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other;
a magnet placed adjacent to the (+) sound pressure controller;
a (−) sound pressure generator for generating (−) sound pressure;
a (−) sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other;
a magnet placed adjacent to the (−) sound pressure controller,
wherein the conductive wire vibrates according to interaction of a magnetic field of the magnet and a magnetic field generated caused by current flowing through the conductive wire of the (+) or (−) sound pressure controller, the gap between the neighboring wires that is not sealed up is changed according to vibration of the two conductive wires, and the sound pressure generated by the (+) or (−) sound pressure generator is varied due to the change in the gap that is not sealed up when the sound pressure passes through the gap, thereby reproducing the sound signal applied to the wire.

8. The sound reproducing system as claimed in claim 5, wherein the sound pressure controller is constructed in such a manner that a conductive wire arranges in a frame having a predetermined shape whose center portion is opened.

9. The sound reproducing system as claimed in claim 5, wherein a thin-film support is placed at the upper or lower part of the plane connecting two neighboring conductive wires, having a predetermined gap from the two wires, and the gap between the thin film support and each wire is sealed up by a thin film.

10. The sound reproducing system as claimed in claim 9, wherein the cross-sectional shape of the thin film sealing up the gap between the thin-film support and each conductive wire is plane.

11. The sound reproducing system as claimed in claim 9, wherein the cross-sectional shape of the thin film sealing up the gap between the thin-film support and each conductive wire is curved plane.

12. The sound reproducing system as claimed in claim 9, wherein the cross-sectional shape of the thin film sealing up the gap between the thin-film support and each conductive wire is plane having at least one bent portion.

13. The sound reproducing system as claimed in claim 5, wherein the thin film is made of at least one of raw rubber, polyester, polyethylene, silicon and teflon.

14. The sound reproducing system as claimed in claim 9, wherein the thin-film support is placed at the side to which sound pressure is provided in the plane connecting the two conductive wires sealed up by the thin film.

15. The sound reproducing system as claimed claim 5, wherein the sound pressure controller further includes a wire tension controller for controlling the length of the conductive wire.

16. The sound reproducing system as claimed in claim 5, wherein the sound pressure controller further includes a wire gap controller for controlling the gap between neighboring conductive wires that is not sealed by the thin film.

17. The sound reproducing system as claimed in claim 5, wherein the gap between neighboring conductive wires that is not sealed up by the thin film is set to 0˜0.5 mm.

18. The sound reproducing system as claimed in claim 17, wherein the gap between neighboring conductive wires that is not sealed up by the thin film is set to 0.3˜0.5 mm.

19. The sound reproducing system as claimed in claim 5, wherein there are multiple sound pressure controllers.

20. The sound reproducing system as claimed in claim 19, wherein the multiple sound pressure controllers have different gaps between neighboring conductive wires, which are not sealed up by the thin film.

21. The sound reproducing system as claimed in claim 19, wherein the multiple sound pressure controllers have different gaps between neighboring conductive wires, which are sealed up by the thin film.

22. The sound reproducing system as claimed in claim 5, wherein the conductive wire of the sound pressure controller is in diameter of 0.1˜0.5 mm.

23. The sound reproducing system as claimed in claim 5, wherein the conductive wire of the sound pressure controller is made of one of copper, gold, platinum, aluminum and iron.

24. The sound reproducing system as claimed in claim 5, wherein at least one portion placed between both ends of the conductive wire arranged in multiple rows or columns is fixed so as to divide the sound pressure controller into a plurality of cells.

25. The sound reproducing system as claimed in claim 9, wherein the cross-section of the thin-film support has a triangular shape.

26. The sound reproducing system as claimed in claim 9, wherein the cross-section of the thin-film support has is square.

27. The sound reproducing system as claimed in claim 5, wherein the conductive wire of the sound pressure controller is divided into a plurality of parts and a sound signal is simultaneously applied to the divided wire parts.

28. The sound reproducing system as claimed in claim 5, wherein the conductive wire is configured of a plurality of wires.

29. The sound reproducing system as claimed in claim 5, wherein the thin film is configured of a fiber.

30. The sound reproducing system as claimed in claim 29, wherein the thin film is formed in such a manner that neighboring conductive wires are wound by the fiber roughly and then coated with at least one of raw rubber, polyester, polyethylene, silicon and Teflon.

31. The sound reproducing system as claimed in claim 5, wherein the cross-section of thin film is defined of the “U” shape.

32. A sound reproducing system using sound pressure, comprising:
a sound pressure generator for generating sound pressure;
a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other; and
a magnet placed adjacent to the sound pressure controller, the magnet having a plurality of sound pressure passage holes,
wherein the conductive wire vibrates according to interaction of a magnetic field of the magnet and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

33. The sound reproducing system as claimed in claim 32, wherein each of the sound pressure passage holes has a circular or polygonal shape.

34. The sound reproducing system as claimed in claim 32, wherein each of the sound pressure passage holes is formed in a shape of long slit.

35. The sound reproducing system as claimed in claim 32, wherein the outlet of each of the sound pressure passage holes is narrower than the inlet thereof.

36. The sound reproducing system as claimed in claim 32, wherein each of the sound pressure passage holes becomes narrower as it goes from its inlet toward its outlet.

37. The sound reproducing system as claimed in claim 32, wherein the borders of the inlet and/or outlet of each of the sound pressure passage holes are rounded off.

38. A sound reproducing system using sound pressure, comprising:
a sound pressure generator for generating sound pressure;
a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other; and
a magnet assembly constructed in a manner that a plurality of magnet pieces are attached onto a support plate having a plurality of sound pressure passage holes, the magnet pieces being placed around the sound pressure passage holes,
wherein the conductive wire vibrates according to interaction of a magnetic field of the magnet assembly and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

39. The sound reproducing system as claimed in claim 38, wherein the magnet assembly is constructed in such a manner that a second sound pressure passage hole is formed in each of the magnet pieces, and the magnet pieces are attached onto the support plate so that the second sound pressure passage holes overlaps with the sound pressure passage holes of the support plate, the second sound pressure passage hole having a shape similar to that of each of the sound pressure passage holes of the support plate.

40. The sound reproducing system as claimed in claim 38, wherein the support plate is curved plane.

41. The sound reproducing system as claimed in claim 38, wherein the support plate has uneven surface.

42. The sound reproducing system as claimed in claim 38, wherein the support plate has a dome, cylindrical or spherical shape.

43. The sound reproducing system as claimed in claim 38, wherein the magnet pieces are attached onto both sides of the support plate.

44. A sound reproducing system using sound pressure, comprising:
a sound pressure generator for generating sound pressure;
a container serving as a passage of the sound pressure generated by the sound pressure generator, a part of the container being opened, the sound pressure being inputted or outputted through the open part of the container;
a sound pressure controller constructed in such a manner that a conductive wire is arranged in multiple rows or columns and a part of gaps between neighboring wires in multiple rows or columns is sealed up by a thin film, the sound pressure controller being constructed in a manner that, when sound signal current is applied to two neighboring conductive wires having the gap between them that is not sealed up by the thin film, directions of currents flowing through the two wires become opposite to each other, the sound pressure controller being attached to the open part of the container; and
a magnet placed adjacent to the sound pressure controller,
wherein the conductive wire vibrates according to interaction of a magnetic field of the magnet and a magnetic field generated caused by current flowing through the conductive wire of the sound pressure controller, the gap between the neighboring wires that is not sealed up is changed according to vibration of the two conductive wires, and the sound pressure generated by the sound pressure generator is varied due to the change in the gap that is not sealed up when the sound pressure passes through the gap, thereby reproducing the sound signal applied to the wire.

45. The sound reproducing system as claimed in claim 44, wherein the container has a cylindrical shape, a predetermined width of the circumference of the cylindrical container is opened, the sound pressure controller is formed in a cylindrical shape and the magnet is formed in a cylindrical shape such that the sound pressure generated by the sound pressure generator is outputted or inputted radially.

46. The sound reproducing system as claimed in claim 44, wherein the container has a cylindrical shape, a predetermined width of a half of the circumference of the cylindrical container is opened, the sound pressure controller is formed in a half-cylindrical shape and the magnet is formed in a half-cylindrical shape such that the sound pressure generated by the sound pressure generator is outputted or inputted radially through the half portion of the cylindrical face of the container.

47. The sound reproducing system as claimed in claim 44, wherein the container has a half-cylindrical shape, a predetermined width of the half-cylindrical face of the container is opened, the sound pressure controller is formed in a half-cylindrical shape and the magnet is formed in a half-cylindrical shape such that the sound pressure generated by the sound pressure generator is outputted or inputted radially through the half-cylindrical face of the container.

48. The sound reproducing system as claimed in claim 44, wherein the container has a polygonal shape, a predetermined width of each of the sides of the polygonal container is opened, the sound pressure controller is formed in a plane shape, and the magnet is formed in a plane shape such that the sound pressure generated by the sound pressure generator is outputted or inputted through each side of the container.

49. The sound reproducing system as claimed in claim 44, wherein the sound pressure controller is formed in a dome shape and the magnet is also formed in a dome shape such that the sound pressure generated by the sound pressure generator is outputted or inputted radially through the dome-shaped face.

50. The sound reproducing system as claimed in claim 44, wherein the magnet is a magnet assembly constructed in a manner that a plurality of magnet pieces are attached onto a support plate having a plurality of sound pressure passage holes, the magnet pieces being placed around the sound pressure passage holes.

51. The sound reproducing system as claimed in claim 44, wherein the inner space of the container is divided into a plurality of sections communicating with one another to extend a sound pressure passage.

52. The sound reproducing system as claimed in claim 44, wherein the sound pressure generator is configured of a motor or solenoid having a fan attached thereto.

53. The sound reproducing system as claimed in claim 52, wherein the fan includes a long wing attached thereto in the length direction of a long support axis.

54. The sound reproducing system as claimed in claim 44, wherein the sound pressure generator is constructed in a manner that a plurality of motor or solenoids each of which has a fan attached thereto are arranged in a row.

55. The sound reproducing system as claimed in claim 44, wherein the sound pressure generator includes an air compressor reciprocating within a specific space, a driver for reciprocating the air compressor, an exhaust valve for discharging compressed air (sound pressure) out of the specific space when the air compressor moves forward in one direction, and an inlet valve for inhaling external air into the specific space when the air compressor moves back in the opposite direction.

56. The sound reproducing system as claimed in claim 55, wherein the sound pressure generator includes a first exhaust valve for discharging compressed air (sound pressure) out of the specific space when the air compressor moves forward in one direction, a first inlet valve for inhaling external air into the space opposite to the moving direction of the air compressor, a second exhaust valve for discharging compressed air (sound pressure) out of the specific space when the air compressor moves back in the opposite direction, and a second inlet valve for inhaling external air into the space opposite to the moving direction of the air compressor.

57. The sound reproducing system as claimed in claim 55, wherein there is multiple sound pressure generators.

58. The sound reproducing system as claimed in claim 55, wherein the motor or solenoid is suspended using a string in a space.

59. The sound reproducing system as claimed in claim 58, wherein the string is made of an elastic material.

60. The sound reproducing system as claimed in claim 58, wherein the string is configured of a plurality of strings.

61. The sound reproducing system as claimed in claim 44, wherein a sound-absorbing material is attached to the inner side of the container or to the inner side of each of divided sections of the inner space of the container.

62. The sound reproducing system as claimed in claim 44, wherein the wire is the printed wire onto a thin film.
